(19) United States
(12) Patent Application Publication
(10) Pub. No.: US 2025/0231712 A1
(43) Pub. Date: Jul. 17, 2025

(54) COMMAND INFORMATION DISTRIBUTION METHOD AND MEMORY STORAGE DEVICE

(71) Applicant: Hosin Global Electronics Co., LTD, Shenzhen (CN)

(72) Inventors: Wei ZHONG, Anhui (CN); Kaidi ZHU, Anhui (CN); Zhi WANG, Anhui (CN); Tsung-Lin Wu, Hsinchu City (TW); Qiao ZHU, Anhui (CN)

(73) Assignee: Hosin Global Electronics Co., LTD, Shenzhen (CN)

(21) Appl. No.: 18/929,489

(22) Filed: Oct. 28, 2024

(30) Foreign Application Priority Data
Jan. 12, 2024 (CN) 202410044156.3

(51) Int. Cl. G06F 3/06

(52) U.S. Cl. CPC G06F 3/0659; G06F 3/0613; G06F 3/0679

(57) ABSTRACT

A command information distribution method includes: arranging a plurality of first command queues used to cache in parallel command information from a flash translation layer; arranging a plurality of second command queues used to cache in parallel command information to be transmitted to the rewritable non-volatile memory module; extracting first command information from a first target queue among the first command queues according to weight information corresponding to the first command queues; performing information format processing on the first command information to generate second command information; and distributing the second command information to a second target queue among the second command queues. A memory storage device is also provided.

### CROSS-REFERENCE TO RELATED APPLICATION

This application claims the priority benefit of China application serial no. 202410044156.3, filed on Jan. 12, 2024. The entirety of the above-mentioned patent application is hereby incorporated by reference herein and made a part of this specification.

### BACKGROUND

### Technical Field

The disclosure relates to a command information management technology, and in particular, relates to a command information distribution method and a memory storage device.

### Description of Related Art

In recent years, the rapid growth of smart phones, tablet computers, and notebook computers has led to a rapid increase in consumer demand for storage media. The rewritable non-volatile memory module (e.g., flash memory) has the characteristics of data non-volatility, power saving, small size, and no mechanical structure. Therefore, the rewritable non-volatile memory module is suitable for being built into the various above-mentioned portable multimedia devices.

Generally, the memory controller performs mapping and translation between logical addresses and physical addresses through a flash translation layer (FTL) in the firmware to manage and access the rewritable non-volatile memory module. However, in common applications of the flash translation layer, the flash translation layer provides command information in accordance with the information format supported by the rewritable non-volatile memory module to the rewritable non-volatile memory module according to the access command, so that the rewritable non-volatile memory module can perform operations corresponding to the access command according to the command information. However, in practice, this arrangement method of unifying the command information format of the flash translation layer and the rewritable non-volatile memory module increases the design difficulty of the flash translation layer. Further, when the type of the rewritable non-volatile memory module is changed, the internal logic of the flash translation layer also needs to be accordingly adjusted, so the maintenance costs increase as well.

### SUMMARY

The disclosure provides a command information distribution method, a memory storage device, and a memory control circuit unit capable of simplifying the design of a flash translation layer and improving the overall performance of the memory storage device.

An exemplary embodiment of the disclosure provides a command information distribution method for a rewritable non-volatile memory module, and the command information distribution method includes the following steps. A plurality of first command queues used to cache in parallel command information from a flash translation layer are arranged. A plurality of second command queues used to cache in parallel command information to be transmitted to the rewritable non-volatile memory module are arranged. First command information is extracted from a first target queue among the plurality of first command queues according to weight information corresponding to the plurality of first command queues. Information format processing is performed on the first command information to generate second command information. The second command information is distributed to a second target queue among the plurality of second command queues to wait for execution by the rewritable non-volatile memory module.

An exemplary embodiment of the disclosure further provides a memory storage device including a connection interface unit, a rewritable non-volatile memory module, and a memory control circuit unit. The connection interface unit is configured to be connected to a host system. The memory control circuit unit is connected to the connection interface unit and the rewritable non-volatile memory module. The memory control circuit unit is configured to arrange a plurality of first command queues used to cache in parallel command information from a flash translation layer, arrange a plurality of second command queues used to cache in parallel command information to be transmitted to the rewritable non-volatile memory module, extract first command information from a first target queue among the plurality of first command queues according to weight information corresponding to the plurality of first command queues, perform information format processing on the first command information to generate second command information, and distribute the second command information to a second target queue among the plurality of second command queues to wait for execution by the rewritable non-volatile memory module.

An exemplary embodiment of the disclosure further provides a memory control circuit unit configured to control a rewritable non-volatile memory module. The memory control circuit unit includes a host interface, a memory interface, and a memory management circuit. The host interface is configured to be connected to a host system. The memory interface is configured to be connected to the rewritable non-volatile memory module. The memory management circuit is connected to the host interface and the memory interface. The memory management circuit is configured to: arrange a plurality of first command queues used to cache in parallel command information from a flash translation layer, arrange a plurality of second command queues used to cache in parallel command information to be transmitted to the rewritable non-volatile memory module, extract first command information from a first target queue among the plurality of first command queues according to weight information corresponding to the plurality of first command queues, perform information format processing on the first command information to generate second command information, and distribute the second command information to a second target queue among the plurality of second command queues to wait for execution by the rewritable non-volatile memory module.

To sum up, through the double-layer configuration of the command queues together with the weight information of the command queues, the command queues are managed and the information format processing is performed on the command information from the flash translation layer. In this way, the design of the flash translation layer is effectively simplified, and the overall performance of the memory storage device is improved.

### BRIEF DESCRIPTION OF THE DRAWINGS

FIG. 1 is a schematic view illustrating a host system, a memory storage device, and an input/output (I/O) device according to an exemplary embodiment of the disclosure.

FIG. 2 is a schematic view illustrating the host system, the memory storage device, and the I/O device according to an exemplary embodiment of the disclosure.

FIG. 3 is a schematic view illustrating a host system and a memory storage device according to an exemplary embodiment of the disclosure.

FIG. 4 is a schematic view illustrating the memory storage device according to an exemplary embodiment of the disclosure.

FIG. 5 is a schematic view illustrating a memory control circuit unit according to an exemplary embodiment of the disclosure.

FIG. 6 is a schematic view illustrating management of a rewritable non-volatile memory module according to an exemplary embodiment of the disclosure.

FIG. 7 is a schematic view illustrating a system architecture using a double-layer command queue according to an exemplary embodiment of the disclosure.

FIG. 8 is a schematic view illustrating distribution of command information according to an exemplary embodiment of the disclosure.

FIG. 9 is a flow chart illustrating a command information distribution method according to an exemplary embodiment of the disclosure.

FIG. 10 is a flow chart illustrating a command information distribution method according to an exemplary embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

Generally, a memory storage device (aka a memory storage system) includes a rewritable non-volatile memory module and a controller (aka a control circuit). The memory storage device may be used together with a host system, so the host system may write data into or read data from the memory storage device.

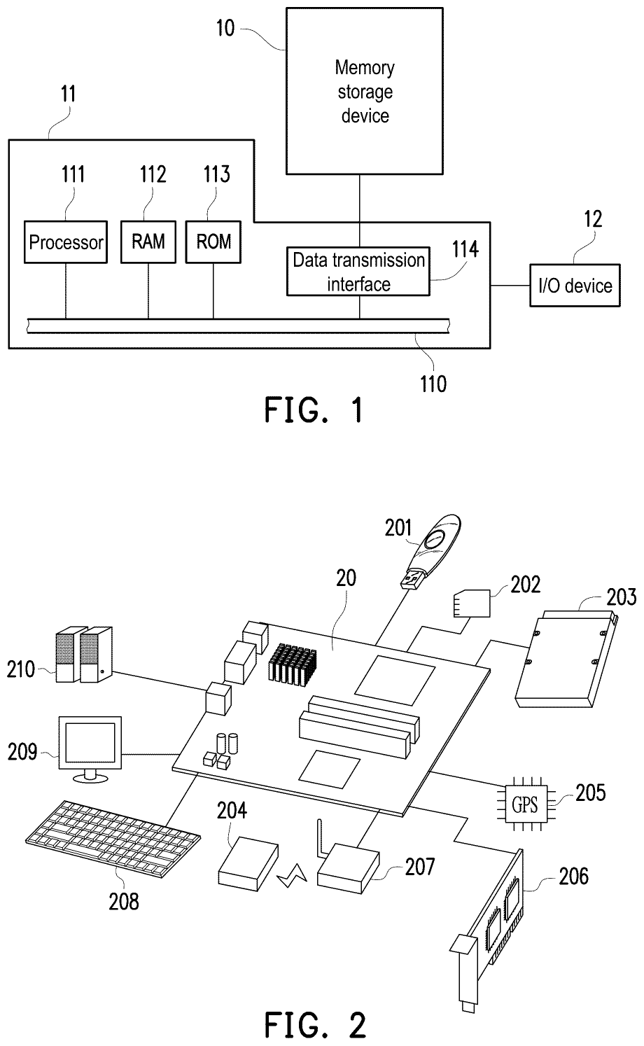

FIG. 1 is a schematic view illustrating a host system, a memory storage device, and an input/output (I/O) device according to an exemplary embodiment of the disclosure. FIG. 2 is a schematic view illustrating the host system, the memory storage device, and the I/O device according to an exemplary embodiment of the disclosure.

With reference to FIG. 1 and FIG. 2, a host system 11 may include a processor 111, a random access memory (RAM) 112, a read only memory (ROM) 113, and a data transmission interface 114. The processor 111, the random access memory 112, the read only memory 113, and the data transmission interface 114 may be connected to a system bus 110.

In an exemplary embodiment, the host system 11 may be connected to a memory storage device 10 through the data transmission interface 114. For instance, the host system 11 may store data into the memory storage device 10 or may read data from the memory storage device 10 through the data transmission interface 114. Further, the host system 111 may be connected to an I/O device 12 through the system bus 110. For instance, the host system 11 may transmit an output signal to the I/O device 12 or receive an input signal from the I/O device 12 through the system bus 110.

In an exemplary embodiment, the processor 111, the random access memory 112, the read only memory 113, and the data transmission interface 114 may be disposed on a motherboard 20 of the host system 11. The number of the data transmission interface 114 may be one or plural. Through the data transmission interface 114, the motherboard 20 may be connected to the memory storage device 10 through wired or wireless methods.

In an exemplary embodiment, the memory storage device 10 may be, for example, a USB flash drive 201, a memory card 202, a solid state drive (SSD) 203, or a wireless memory storage device 204. The wireless memory storage device 204 may be, for example, a memory storage device based on various wireless communication technologies, such as a near field communication (NFC) memory storage device, a wireless fidelity (WiFi) memory storage device, a Bluetooth memory storage device, or a low energy Bluetooth memory storage device (e.g., iBeacon). Besides, the motherboard 20 may also be connected to various I/O devices including a global positioning system (GPS) module 205, a network interface card 206, a wireless transmission device 207, a keyboard 208, a display 209, and a speaker 210 through the system bus 110. For instance, in an exemplary embodiment, the motherboard 20 may access the wireless memory storage device 204 through the wireless transmission device 207.

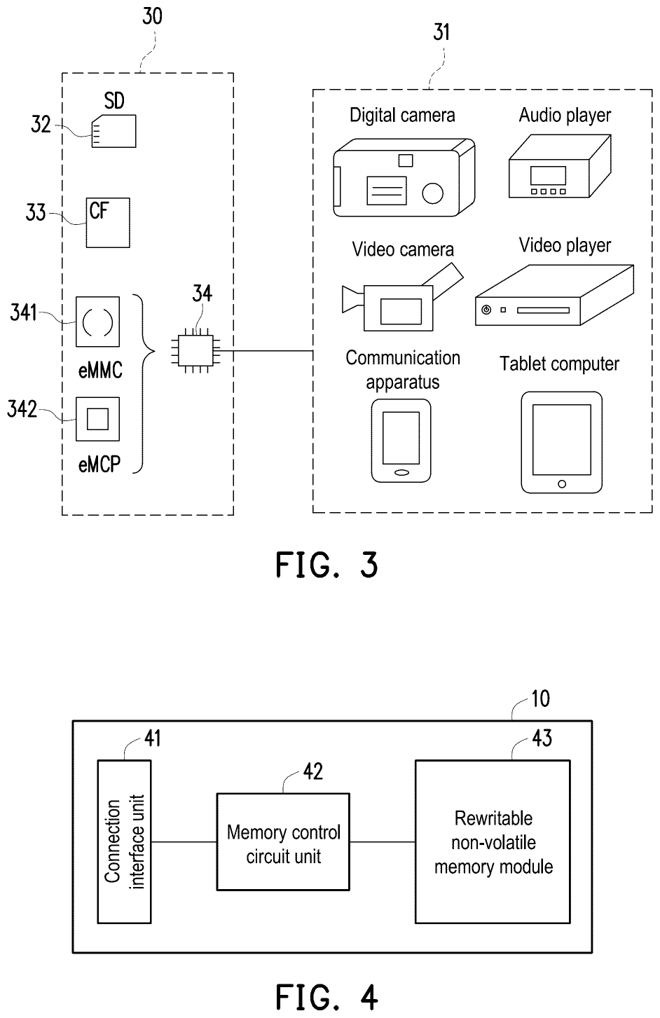

In an exemplary embodiment, the host system 11 may be a computer system. In an exemplary embodiment, the host system 11 may be any system capable of substantially cooperating with the memory storage device for storing data. In an exemplary embodiment, the memory storage device 10 and the host system 11 may include a memory storage device 30 and a host system 31 of FIG. 3 respectively.

FIG. 3 is a schematic view illustrating a host system and a memory storage device according to an exemplary embodiment of the disclosure. With reference to FIG. 3, the memory storage device 30 may be used together with the host system 31 to store data. For instance, the host system 31 may be a system such as a digital camera, a video camera, a communication apparatus, an audio player, a video player, or a tablet computer. For instance, the memory storage device 30 may be a non-volatile memory storage device used by the host system 31, such as a secure digital (SD) card 32, a compact flash (CF) card 33, or an embedded storage device 34. The embedded storage device 34 includes various embedded storage devices capable of directly connecting a memory module onto a substrate of the host system, such as an embedded Multi Media Card (eMMC) 341 and/or an embedded Multi Chip Package (eMCP) storage device 342.

FIG. 4 is a schematic view illustrating the memory storage device according to an exemplary embodiment of the disclosure. With reference to FIG. 4, the memory storage device 10 includes a connection interface unit 41, a memory control circuit unit 42, and a rewritable non-volatile memory module 43.

The connection interface unit 41 is configured to connect the memory storage device 10 to the host system 11. The memory storage device 10 may communicate with the host system 11 through the connection interface unit 41. In an exemplary embodiment, the connection interface unit 41 is compatible with the peripheral component interconnect express (PCI Express) standard. However, it should be noted that the disclosure is not limited thereto, and the connection interface unit 41 may also comply with the Serial Advanced Technology Attachment (SATA) standard, the Parallel Advanced Technology Attachment (PATA) standard, the Institute of Electrical and Electronic Engineers (IEEE) 1394 standard, the Universal Serial Bus (USB) standard, the Secure Digital (SD) interface standard, the Ultra High Speed-I (UHS-I) interface standard, the Ultra High Speed-II (UHS-II) interface standard, the Memory Stick (MS) interface standard, the Multi Chip Package (MCP) interface standard, the Multi Media Card (MMC) interface standard, the embedded Multi Media Card (eMMC) interface standard, the Universal Flash Storage (UFS) interface standard, the embedded Multi Chip Package (eMCP) interface standard, the Compact Flash (CF) interface standard, the Integrated Device Electronics (IDE) interface standard, or other applicable standards. The connection interface unit 41 may be packaged in a chip together with the memory control circuit unit 42, or the connection interface unit 41 may be disposed outside a chip including the memory control circuit unit 42.

The memory control circuit unit 42 is connected to the connection interface unit 41 and the rewritable non-volatile memory module 43. The memory control circuit unit 42 is configured to execute a plurality of logic gates or control commands which are implemented in a form of hardware or firmware and to execute operations of data writing, reading, or erasing in the rewritable non-volatile memory module 43 according to the commands of the host system 11.

The rewritable non-volatile memory module 43 is configured to store data written by the host system 11. The rewritable non-volatile memory module 43 may include a single level cell (SLC) NAND flash memory module (i.e., a flash memory module capable of storing 1 bit in one memory cell), a multi level cell (MLC) NAND flash memory module (i.e., a flash memory module capable of storing 2 bits in one memory cell), a triple level cell (TLC) NAND flash memory module (i.e., a flash memory module capable of storing 3 bits in one memory cell), a quad level cell (QLC) NAND flash memory module (i.e., a flash memory module capable of storing 4 bits in one memory cell), other flash memory modules, or any memory module having the same features.

Each memory cell in the rewritable non-volatile memory module 43 stores one bit or more bits with a change in voltage (referred to as “threshold voltage” hereinafter). Specifically, a charge trapping layer is provided between a control gate of each memory cell and a channel. By applying a write voltage to the control gate, the amount of electrons of the charge trapping layer may be changed, and the threshold voltage of the memory cell is thereby changed. The operation of changing the threshold voltage of the memory cell is also referred to as “writing data to the memory cell” or “programming the memory cell”. Each memory cell in the rewritable non-volatile memory module 43 has a plurality of storage states according to the change of the threshold voltage. The storage state of the memory cell may be determined by applying a reading voltage, and the one or more bits stored in the memory cell is thereby obtained.

In an exemplary embodiment, the memory cells of the rewritable non-volatile memory module 43 may form a plurality of physical programming units, and the physical programming units may form a plurality of physical erasing units. Specifically, the memory cells on the same word line may form one physical programming unit or a plurality of physical programming units. If each of the memory cells stores 2 bits or more bits, the physical programming units on the same word line may at least be categorized as a lower physical programming unit and an upper physical programming unit. For instance, a least significant bit (LSB) of one memory cell belongs to the lower physical programming unit, and a most significant bit (MSB) of one memory cell belongs to the upper physical programming unit. Generally, in an MLC NAND flash memory, the writing speed of the lower physical programming unit may be greater than the writing speed of the upper physical programming unit, and/or the reliability of the lower physical programming unit is greater than the reliability of the upper physical programming unit.

In an exemplary embodiment, the physical programming units are the smallest units for programming. That is, the physical programming units are the minimum units for writing data. For example, the physical programming units may be physical pages or physical sectors. When the physical programming units are the physical pages, these physical programming units may include a data bit region and a redundancy bit region. The data bit region includes a plurality of physical sectors configured for storing user data, and the redundancy bit region is configured for storing system data (e.g., management data such as an error correcting code). In an exemplary embodiment, the data bit region includes 32 physical sectors, and a size of each of the physical sectors is 512 bytes (B). However, in other exemplary embodiments, the data bit region may also include 8, 16, or more or fewer physical sectors. The size of each of the physical sectors may be greater or smaller. On the other hand, the physical erasing units are the minimum units for erasing. That is, each of the physical erasing units contains the least number of memory cells to be erased together. The physical erasing units are physical blocks, for example.

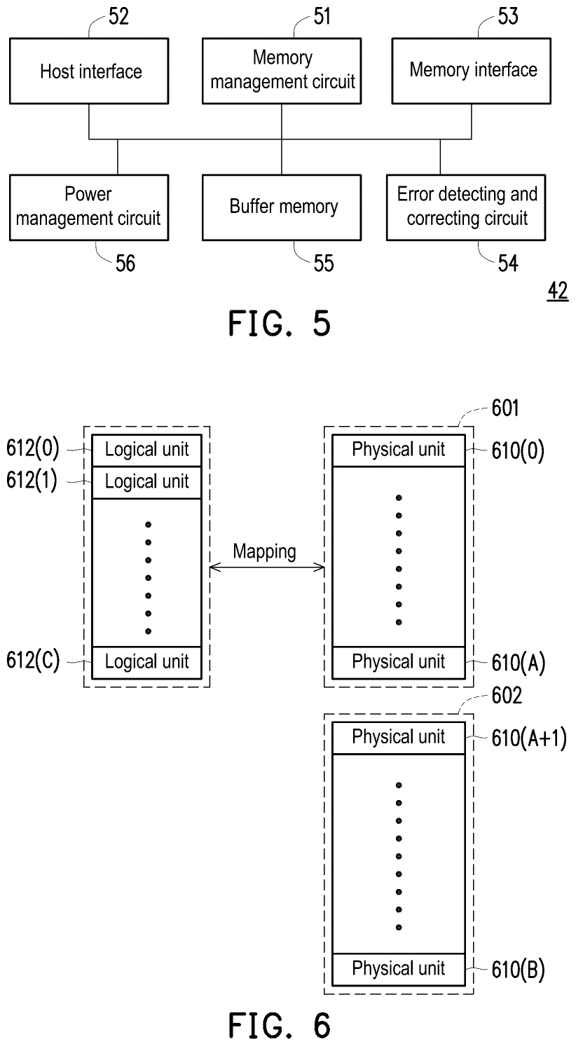

FIG. 5 is a schematic view illustrating a memory control circuit unit according to an exemplary embodiment of the disclosure. With reference to FIG. 5, the memory control circuit unit 42 includes a memory management circuit 51, a host interface 52, a memory interface 53, and an error detecting and correcting circuit 54.

The memory management circuit 51 is configured to control overall operations of the memory control circuit unit 42. Specifically, the memory management circuit 51 has a plurality of control commands. When the memory storage device 10 runs, these control commands are executed to perform various operations such as data writing, data reading, and data erasing. The following description of the operation of the memory management circuit 51 is equivalent to the description of the operation of the memory control circuit unit 42.

In an exemplary embodiment, the control commands of the memory management circuit 51 are implemented in a form of firmware. For instance, the memory management circuit 51 has a microprocessor unit (not shown) and a read-only memory (not shown), and these control commands are burnt into the read-only memory. When the memory storage device 10 works, the control commands are executed by the microprocessor unit for performing various operations, such as data writing, data reading, and data erasing.

In an exemplary embodiment, the control commands of the memory management circuit 51 may also be stored in a specific region (for example, a system region in the memory module exclusively used for storing system data) of the rewritable non-volatile memory module 43 in the form of program codes. Moreover, the memory management circuit 51 has the microprocessor unit (not shown), the read-only memory (not shown), and a random access memory (not shown). In particular, this read-only memory has a boot code, and when the memory control circuit unit 42 is enabled, the boot code is executed by the microprocessor unit first for loading the control commands stored in the rewritable non-volatile memory module 43 to the random access memory of the memory management circuit 51. After that, the microprocessor unit executes these control commands for various operations such as data writing, data reading, and data erasing.

In an exemplary embodiment, the control commands of the memory management circuit 51 may also be implemented in a hardware form. For example, the memory management circuit 51 includes a microprocessor, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are connected to the microprocessor. The memory cell management circuit is configured to manage the memory cells or the memory cell groups of the rewritable non-volatile memory module 43. The memory writing circuit is configured to issue a writing command sequence to the rewritable non-volatile memory module 43 so as to write data into the rewritable non-volatile memory module 43. The memory reading circuit is configured to issue a reading command sequence to the rewritable non-volatile memory module 43 so as to read data from the rewritable non-volatile memory module 43. The memory erasing circuit is configured to issue an erasing command sequence to the rewritable non-volatile memory module 43 so as to erase data from the rewritable non-volatile memory module 43. The data processing circuit is configured to process data to be written into the rewritable non-volatile memory module 43 and data to be read from the rewritable non-volatile memory module 43. Each of the writing command sequence, the reading command sequence, and the erasing command sequence may include one or more program codes or command codes and is configured to instruct the rewritable non-volatile memory module 43 to execute corresponding data operations such as writing, reading, and erasing. In an exemplary embodiment, the memory management circuit 51 may further issue other types of command sequences to the rewritable non-volatile memory module 43 to instruct the execution of corresponding operations.

The host interface 52 is connected to the memory management circuit 51. The memory management circuit 51 may communicate with the host system 11 through the host interface 52. The host interface 52 may be configured to receive and identify commands and data sent from the host system 11. For instance, the commands and the data sent from the host system 11 may be transmitted to the memory management circuit 51 through the host interface 52. In addition, the memory management circuit 51 may transmit data to the host system 11 through the host interface 52. In this exemplary embodiment, the host interface 52 is compatible with the PCI Express standard. However, it should be understood that the disclosure is not limited thereto, and the host interface 52 may also be compatible to the SATA standard, the PATA standard, the IEEE 1394 standard, the USB standard, the SD standard, the UHS-I standard, the UHS-II standard, the MS standard, the MMC standard, the eMMC standard, the UFS standard, the CF standard, the IDE standard, or other applicable standards for data transmission.

The memory interface 53 is coupled to the memory management circuit 51 and is configured to access the rewritable non-volatile memory module 43. For instance, the memory management circuit 51 may access the rewritable non-volatile memory module 43 through the memory interface 53. In other words, data to be written to the rewritable non-volatile memory module 43 is converted into a format acceptable to the rewritable non-volatile memory module 43 through the memory interface 53. Specifically, when the memory management circuit 51 is to access the rewritable non-volatile memory module 43, the memory interface 53 sends the corresponding command sequences. For instance, the command sequences may include a writing command sequence instructing data-writing, a reading command sequence instructing data-reading, an erasing command sequence instructing data-erasing, and corresponding command sequences configured for instructing various memory operations (e.g., changing reading voltage levels or executing garbage collection, etc.). The command sequences are generated by, for example, the memory management circuit 51, and are sent to the rewritable non-volatile memory module 43 through the memory interface 53. These command sequences may include one or more signals or data on the bus. These signals or data may include command codes or program codes. For example, in a reading command sequence, information such as a read identification code and a memory address may be included.

The error detecting and correcting circuit 54 (aka a decoding circuit) is connected to the memory management circuit 51 and is configured to execute an error detecting and correcting operation to ensure the correctness of data. To be specific, when the memory management circuit 51 receives a write command from the host system 11, the error detecting and correcting circuit 54 generates a corresponding error correcting (ECC) code and/or an error detecting code (EDC) for the data corresponding to the write command, and the memory management circuit 51 writes the data corresponding to the write command and the corresponding error correcting code and/or the error detecting code to the rewritable non-volatile memory module 43. Afterwards, when the memory management circuit 51 reads the data from the rewritable non-volatile memory module 43, the corresponding error correcting code and/or the error detecting code is simultaneously read, and the error detecting and correcting circuit 54 executes error detecting and correcting operations for the read data based on the error correcting code and/or the error detecting code.

In an exemplary embodiment, the memory control circuit unit 42 further includes a buffer memory 55 and a power management circuit 56. The buffer memory 55 is connected to the memory management circuit 51 and is used to temporarily store data. The power management unit 56 is connected to the memory management circuit 51 and is configured to control power of the memory storage device 10.

In an exemplary embodiment, the rewritable non-volatile memory module 43 of FIG. 4 may include a flash memory module. In an exemplary embodiment, the memory control circuit unit 42 of FIG. 4 may include a flash memory controller. In an exemplary embodiment, the memory management circuit 51 of FIG. 5 may include a flash memory management circuit.

FIG. 6 is a schematic view illustrating management of a rewritable non-volatile memory module according to an exemplary embodiment of the disclosure. With reference to FIG. 6, the memory management circuit 51 may logically group physical units 610(0) to 610(B) in the rewritable non-volatile memory module 43 into a storage region 601 and a spare region 602.

In an exemplary embodiment, one physical unit refers to one physical address or one physical programming unit. In an exemplary embodiment, one physical unit may also be composed of a plurality of consecutive or inconsecutive physical addresses. In an exemplary embodiment, one physical unit may also refer to a virtual block (VB). A virtual block may include a plurality of physical addresses or a plurality of physical programming units.

The physical units 610(0) to 610(A) in the storage region 601 are configured to store user data (for example, user data from the host system 11 in FIG. 1). For instance, the physical units 610(0) to 610(A) in the storage region 601 may be stored with valid data and invalid data. The physical units 610(A+1) to 610(B) in the spare region 602 are not stored with data (e.g., the valid data). For instance, if one physical unit does not store valid data, then this physical unit may be associated with (or added to) the spare region 602. Moreover, the physical units in the spare region 602 (or physical units not storing valid data) may be erased. When writing new data, one or more physical units may be extracted from the spare region 602 to store this new data. In an exemplary embodiment, the spare region 602 is also known as a free pool.

The memory management circuit 51 may configure logical units 612(0) to 612(C) to map the physical units 610(0) to 610(A) in the storage region 601. In an exemplary embodiment, one logical unit corresponds to one logical address. For example, one logical address may include one or a plurality of logical block addresses (LBAs) or other logical management units. In an exemplary embodiment, one logical unit may also correspond to one logical programming unit or be composed of a plurality of consecutive or inconsecutive logical addresses.

The memory management circuit 51 may record a management data (aka logical-to-physical mapping information) between the logical units and the physical units to at least one logical-to-physical mapping table. When the host system 11 is intended to read data from the memory storage device 10 or write data to the memory storage device 10, the memory management circuit 51 may access the rewritable non-volatile memory module 43 according to information in this logical-to-physical mapping table.

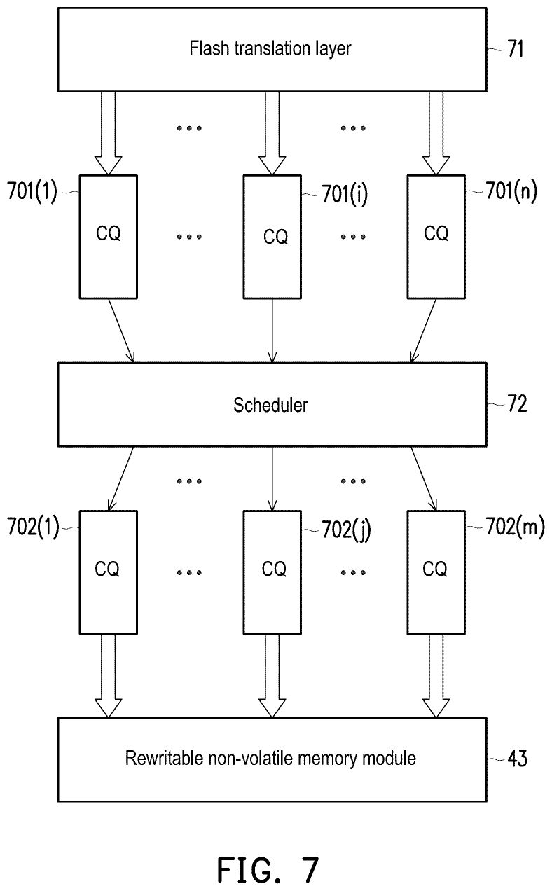

FIG. 7 is a schematic view illustrating a system architecture using a double-layer command queue according to an exemplary embodiment of the disclosure. With reference to FIG. 7, in an exemplary embodiment, the memory management circuit 51 may configure a plurality of command queues (also known as first command queues) 701(1) to 701(n). n may be an integer greater than 1. The command queues 701(1) to 701(n) may be used to cache in parallel command information from a flash translation layer (FTL) 71. For instance, the flash translation layer 71 may be used to perform mapping and translation between logical units and physical units. A person having ordinary skill in the art should be able to clearly understand the specific functions of the flash translation layer 71, so description thereof is not elaborated herein.

In an exemplary embodiment, the memory management circuit 51 may configure a plurality of command queues (also known as second command queues) 702(1) to 702(m). m may be an integer greater than 1. The command queues 702(1) to 702(m) are used to cache in parallel command information to be transmitted to the rewritable non-volatile memory module 43. The total number of command queues 701(1) to 701(n) may be less than or equal to the total number of command queues 702(1) to 702(m).

In an exemplary embodiment, the total number of the command queues 702(1) to 702 (m) may be related to the total number of memory chips (e.g., dies) in the rewritable non-volatile memory module 43. For instance, assuming that the rewritable non-volatile memory module 43 includes four memory chips (e.g., four dies), the total number of the command queues 702(1) to 702(m) may be 4. Therefore, each of the command queues 702(1) to 702(m) may be used to cache command information to be provided to a specific memory chip.

In an exemplary embodiment, the total number of the command queues 702(1) to 702 (m) may also be related to the total number of memory planes in the rewritable non-volatile memory module 43. For instance, assuming that the rewritable non-volatile memory module 43 includes 4 memory chips (e.g., 4 dies) and each memory chip includes 4 memory planes, the total number of command queue 702(1) to 702(m) is 16 (i.e., 4×4=16). Therefore, each of the command queues 702(1) to 702(m) may be used to cache command information to be provided to a specific memory plane.

In an exemplary embodiment, each of the command queues 701(1) to 701(n) corresponds to (e.g., is bound to or associated with) one of the command queues 702(1) to 702 (m). For instance, assuming that the command queue 701(i) corresponds to the command queue 702 (j), the command queues 701(i) and 702 (j) both correspond to the same memory chip in the rewritable non-volatile memory module 43.

In an exemplary embodiment, the memory management circuit 51 may also configure and run a scheduler 72. For instance, the scheduler 72 may be implemented as software, firmware, or hardware executed by memory management circuit 51. In the following exemplary embodiments, the operations performed by the scheduler 72 may also be considered to be performed by the memory management circuit 51.

In an exemplary embodiment, the scheduler 72 may extract at least one command information (also referred to as first command information) from one of the command queues 701 (1) to 701(n) (also referred to as a first target queue) based on weight information corresponding to the command queues 701(1) to 701(n). The scheduler 72 may perform information format processing (e.g., information format conversion) on the first command information to generate corresponding command information (also referred to as second command information). After the second command information is generated, the scheduler 72 may allocate the second command information to one of the command queues 702(1) to 702(m) (also referred to as a second target queue) to wait for execution by the rewritable non-volatile memory module 43. It should be noted that the first target queue and the second target queue may correspond to the same memory chip in the rewritable non-volatile memory module 43.

In an exemplary embodiment, a piece of command information output by the flash translation layer 71 may carry necessary information related to the command information, such as command type information, data length information, and physical address information. The command type information reflects the type of the access operation indicated by the command information. The data length information reflects the length of the data to be accessed as indicated by the command information. The physical address information indicates the physical address that the command information indicates to access.

Taking the command information corresponding to a read command as an example, it is assumed that the read command is used to instruct to read data with a data length of 16 KB from a physical address A. The command information output by the flash translation layer 71 according to the read command may include {read, 16 KB, physical address A} and other necessary information related to the read command. The command information may then be pushed to one of the command queues 701(1) to 701(n) for caching to wait for retrieval by the scheduler 72. For instance, assuming that the physical address A belongs to a memory chip in the rewritable non-volatile memory module 43 and both the command queues 701(i) and 702 (j) correspond to this memory chip, the flash translation layer 71 may push the command information into the command queue 701(i).

In an exemplary embodiment, the scheduler 72 may perform information format processing (e.g., information format conversion) on the first command information extracted from the first target queue (e.g., command queue 701(i)) according to the command information format supported by the rewritable non-volatile memory module 43, so as to generate the second command information that complies with the command information format supported by the rewritable non-volatile memory module 43. For instance, the second command information may include necessary information originally enclosed in the first command information and related to a specific access operation (e.g., command type information, data length information, and physical address information, etc.).

In an exemplary embodiment, the first command information carries necessary information in a simple information format. Therefore, the information format of the first command information may not conform to the command information format supported by the rewritable non-volatile memory module 43. However, after the scheduler 72 converts the first command information into the second command information that complies with the command information format supported by the rewritable non-volatile memory module 43, the scheduler 72 may allocate (e.g., add) the second command information to the second target queue (e.g., command queue 702 (j)) to wait for execution by the rewritable non-volatile memory module 43.

In an exemplary embodiment, the command queues 701(1) to 701(n) (i.e., the first command queue) configured in parallel at the front end of the scheduler 72 (i.e., between the flash translation layer 71 and the scheduler 72) and the command queues 702(1) to 702(m) (i.e., the second command queue) configured in parallel at the back end of the scheduler 72 (i.e., between the scheduler 72 and the rewritable non-volatile memory module 43) can operate independently without interfering with each other. Therefore, the operation efficiency of the flash translation layer 71, the scheduler 72, and the rewritable non-volatile memory module 43 may be improved, and the overall performance of the memory storage device 10 is enhanced.

In an exemplary embodiment, by simplifying the data format of the first command information output by the flash translation layer 71 and having the scheduler 72 generate second command information that complies with the command information format supported by the rewritable non-volatile memory module 43 according to the first command information, the coupling complexity between the flash translation layer 71 and the rewritable non-volatile memory module 43 may be lowered. In addition, when replacing a different type of rewritable non-volatile memory module 43, the flash translation layer 71 may be modified as little as possible or even without modification, and the second command information that satisfies the operation requirements of the new rewritable non-volatile memory module 43 may be generated by the scheduler 72 only by appropriately modifying the logic of the scheduler 72.

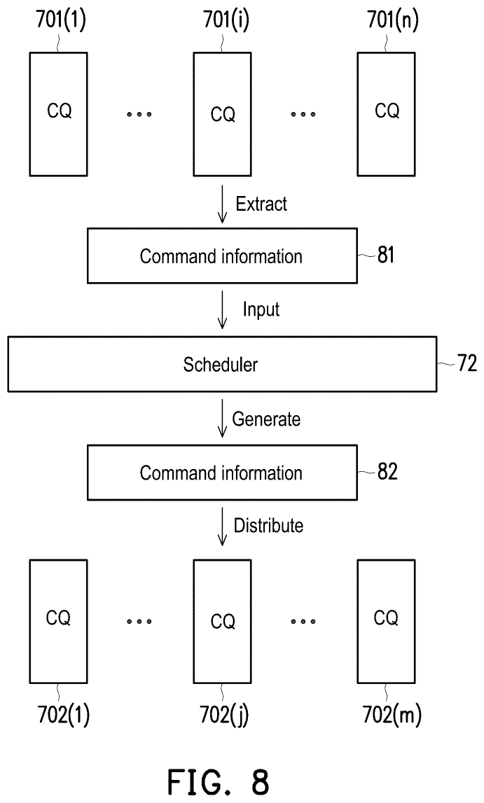

FIG. 8 is a schematic view illustrating distribution of command information according to an exemplary embodiment of the disclosure. With reference to FIG. 8, in an exemplary embodiment, the scheduler 72 may set the command queues 701(i) and 702 (j) as the first target queue and the second target queue, respectively. The scheduler 72 may extract command information 81 (i.e., the first command information) from the command queue 701(i) (i.e., the first target queue). The scheduler 72 may perform information format processing (e.g., information format conversion) on the command information 81 and generate command information 82 (i.e., the second command information). Finally, the scheduler 72 may distribute (e.g., add) the command information 82 to the command queue 702 (j) (i.e., the second target queue) to wait for execution by the rewritable non-volatile memory module 43.

In an exemplary embodiment, the scheduler 72 may set the weight values corresponding to the command queues 701(1) to 701(n) according to the number of command information cached in the command queues 701(1) to 701(n), respectively. Taking the command queue 701 (i) as an example, the weight value corresponding to the command queue 701(i) may be positively correlated to the total number of command information currently cached in the command queue 701(i). For instance, assuming that there are currently 3 pieces of command information cached in the command queue 701(i), the scheduler 72 may set the weight value corresponding to the command queue 701(i) to “3”, and the rest may be deduced by analogy.

In an exemplary embodiment, the scheduler 72 may determine the first target queue from the command queues 701(1) to 701(n) according to the weight information corresponding to the command queues 701(1) to 701(n). For instance, the scheduler 72 may perform a queue selection operation according to the weight information to determine the first target queue. In this queue selection operation, the scheduler 72 may compare the weight values corresponding to the command queues 701(1) to 701(n). Next, the scheduler 72 may select one of the command queues 701(1) to 701(n) (e.g., the command queue 701(i)) as the first target queue according to a comparison result. For instance, the first target queue may be a command queue corresponding to a maximum or relatively large weight value among the command queues 701(1) to 701(n).

In an exemplary embodiment, after the first target queue is selected, the scheduler 72 may continue to extract the first command information from the first target queue and perform command merging on the first target queue. The details of command merging are described in the following paragraphs.

In an exemplary embodiment, in response to a specific command queue (also referred to as a first candidate queue) among the command queues 701(1) to 701(n) being selected as the first target queue multiple times in a plurality of queue selection operations executed successively, the scheduler 72 may update a count value corresponding to the first candidate queue. For instance, assuming that in three consecutively executed queue selection operations, the command queue 701(i) is selected as the first target queue three times in a row, the scheduler 72 may update the count value corresponding to the command queue 701(i) to “3”. Therefore, the count value may reflect the total number of times that the first candidate queue (e.g., the command queue 701 (i)) is selected as the first target queue for multiple consecutive times.

In an exemplary embodiment, in response to the count value corresponding to the first candidate queue satisfying a predetermined condition, the scheduler 72 may mark the first candidate queue (for example, mark it as invalid), so that the first candidate queue is excluded from the next queue selection operation. That is, after the first candidate queue is marked, the marked first candidate queue does not participate in the next queue selection operation. In this way, a specific command queue among the command queues 701(1) to 701(n) is prevented from continuously occupying the execution right, thereby causing other command queues to be ignored for a long time.

In an exemplary embodiment, the scheduler 72 may determine whether the count value corresponding to the first candidate queue is greater than a threshold value. In response to the count value corresponding to the first candidate queue being greater than the threshold value, the scheduler 72 may determine that the count value corresponding to the first candidate queue satisfies a predetermined condition. However, if the count value corresponding to the first candidate queue is not greater than the threshold value, the scheduler 72 may determine that the count value corresponding to the first candidate queue does not satisfy the predetermined condition.

In an exemplary embodiment, in response to the first candidate queue not being selected as the first target queue for consecutive times, the scheduler 72 may reset the count value corresponding to the first candidate queue. For instance, assuming that the first candidate queue is selected as the first target queue twice in succession, but in the next queue selection operation, another command queue (also referred to as the second candidate queue) in the command queues 701(1) to 701(n) is selected as the first target queue instead, herein, in response to the first candidate queue not being selected as the first target queue for consecutive times, the scheduler 72 may reset the count value corresponding to the first candidate queue, for example, returning the count value corresponding to the first candidate queue to zero.

In an exemplary embodiment, after the first target queue is selected, the scheduler 72 may perform command merging on the first target queue. In command merging, the scheduler 72 may select the command information that is sequenced at a first position in the first target queue (also referred to as first target command information). Next, the scheduler 72 may traverse the remaining command information in the first target queue that is sequenced after the first target command information based on the first target command information.

In an exemplary embodiment, in the command merging, the scheduler 72 may determine whether the first target command information and any command information in the first target queue satisfy a specific condition (also referred to as a first condition). In response to the first target command information and at least one command information in the first target queue (also referred to as second target command information) satisfying the first condition, the scheduler 72 may merge the first target command information with the second target command information. For instance, in response to the first target command information and the second target command information satisfying the first condition, the scheduler 72 may merge the second target command information into the first position in the first target queue.

In an exemplary embodiment, in the command merging, the scheduler 72 may further determine whether the first target command information and any command information in the first target queue satisfy another condition (also referred to as a second condition). In response to the first target command information and at least one command information in the first target queue (also referred to as third target command information) satisfying the second condition, the scheduler 72 may adjust the order of the third target command information. For instance, in response to the first target command information and the third target command information satisfying the first condition, the scheduler 72 may adjust the third target command information to be sequentially sequenced after the first target command information.

In an exemplary embodiment, after last command information or command information with a barrier flag in the first target queue is detected, the scheduler 72 may end the command merging for the first target queue. The scheduler 72 may then perform the aforementioned queue selection operation again.

In an exemplary embodiment, in the command merging, after the first target command information is selected, the scheduler 72 may determine whether the first target command information and any command information in the first target queue belong to the same type of command. For instance, assuming that the first target command information and a specific command information in the first target queue are both write commands, read commands, or erase commands, the scheduler 72 may determine that the first target command information and this specific command information are of the same type of commands, and the rest may be deduced by analogy.

In an exemplary embodiment, if the first target command information and specific command information (also referred to as candidate command information) in the first target queue belong to the same type of command, the scheduler 72 may determine whether the first target command information and this candidate command information correspond to a same memory page or different memory planes in the rewritable non-volatile memory module 43.

In an exemplary embodiment, in response to the first target command information and this candidate command information corresponding to the same memory page or different memory planes, the scheduler 72 may determine that the first target command information and this candidate command information (i.e., the second target command information) satisfy the first condition. However, if the first target command information and this candidate command information do not correspond to the same memory page or different memory planes, the scheduler 72 may determine that the first target command information and this candidate command information do not satisfy the first condition.

In an exemplary embodiment, the scheduler 72 may also determine whether the first target command information and the candidate command information correspond to a plurality of consecutive memory pages in the rewritable non-volatile memory module 43. In an exemplary embodiment, in response to the first target command information and this candidate command information corresponding to a plurality of consecutive memory pages in the rewritable non-volatile memory module 43, the scheduler 72 may determine that the first target command information and this candidate command information (i.e., the third target command information) satisfy the second condition. However, if the first target command information and this candidate command information do not correspond to a plurality of consecutive memory pages in the rewritable non-volatile memory module 43, the scheduler 72 may determine that the first target command information and this candidate command information do not satisfy the second condition.

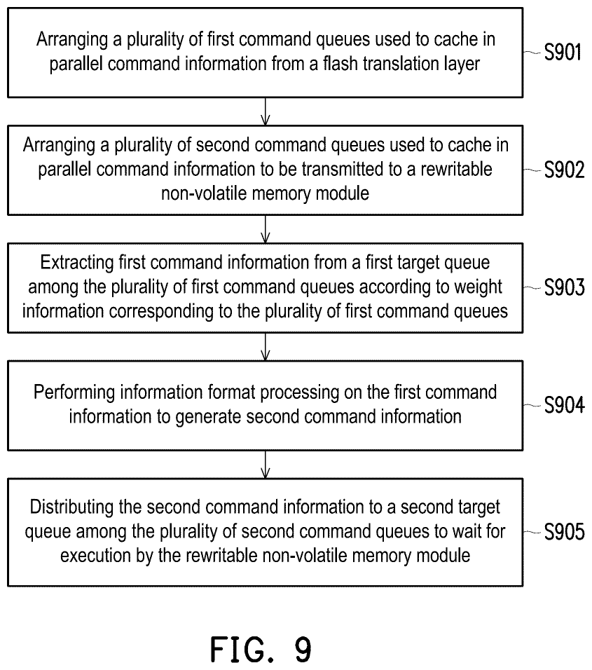

In an exemplary embodiment, by concentrating and merging a plurality of command information satisfying the first condition in the first target queue to the first position in the first target queue, when the rewritable non-volatile memory module 43 subsequently executes the command information corresponding to the first position, the rewritable non-volatile memory module 43 may complete the operations respectively indicated by the original multiple command information by accessing a single memory page or accessing multiple memory planes in parallel. In this way, the performance of the rewritable non-volatile memory module 43 may be improved. On the other hand, by continuously sorting the command information satisfying the second condition in the first target queue, the rewritable non-volatile memory module 43 may subsequently access a plurality of continuous memory pages continuously according to the continuously sequenced command information. In this way, the performance of the rewritable non-volatile memory module 43 may also be improved. FIG. 9 is a flow chart illustrating a command information distribution method according to an exemplary embodiment of the disclosure. With reference to FIG. 9, in step S901, a plurality of first command queues used to cache in parallel command information from a flash translation layer are arranged. In step S902, a plurality of second command queues used to cache in parallel command information to be transmitted to the rewritable non-volatile memory module are arranged. In step S903, first command information is extracted from a first target queue among the plurality of first command queues according to weight information corresponding to the plurality of first command queues. In step S904, information format processing is performed on the first command information to generate second command information. In step S905, the second command information is distributed to a second target queue among the plurality of second command queues to wait for execution by the rewritable non-volatile memory module.

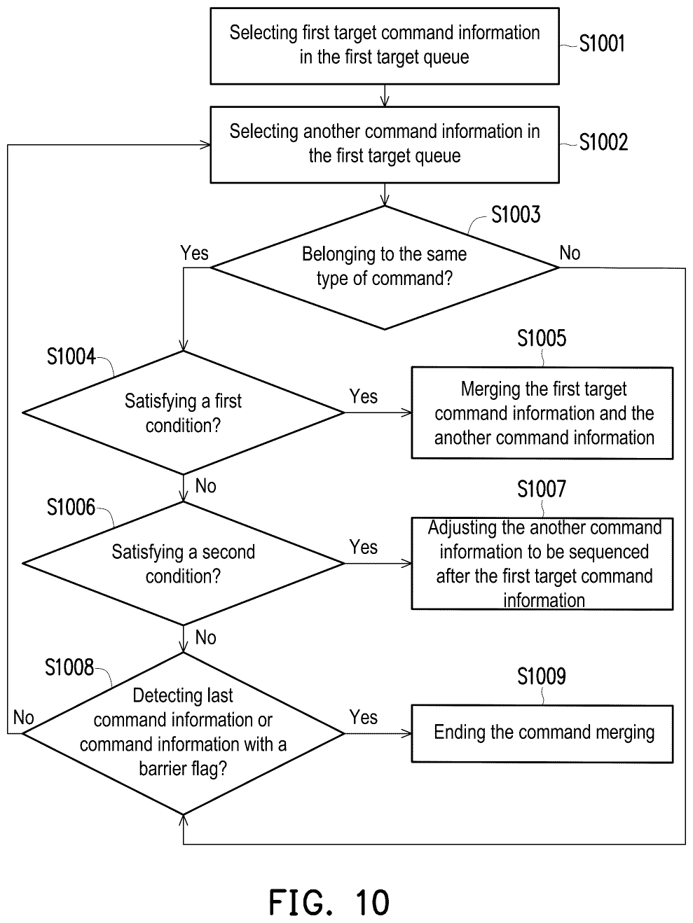

FIG. 10 is a flow chart illustrating a command information distribution method according to an exemplary embodiment of the disclosure. With reference to FIG. 10, after the merging of the commands of the first target queue is started, in step S1001, first target command information in the first target queue is selected. For instance, the first target command information refers to the command information sequenced at the first position in the first target queue. In step S1002, another command information in the first target queue is selected. In step S1003, it is determined whether the first target command information and the another command information are of the same type of command. If the first target command information and the another command information are of the same type of command, in step S1004, it is determined whether the first target command information and the another command information satisfy a first condition. If the first target command information and the another command information satisfy the first condition, in step S1005, the first target command information and the another command information are merged.

If the first target command information and the another command information do not satisfy the first condition, in step S1006, it is determined whether the first target command information and the another command information satisfy the second condition. If the first target command information and the another command information satisfy the second condition, in step S1007, the another command information is adjusted to be sequenced after the first target command information.

In addition, if the determination result of step S1003 or step S1006 is no, the process proceeds to step S1008. In step S1008, it is determined whether last command information in the first target queue or command information with a barrier flag in the first target queue is detected. If the last command information in the first target queue or the command information with a barrier flag in the first target queue is detected, in step S1009, the command merging of the first target queue is ended. However, if the last command information in the first target queue or the command information with a barrier flag in the first target queue is not detected, the process returns to step S1002 to select another command information in the first target queue and execute the subsequent steps.

The steps in FIG. 9 and FIG. 10 are described in detail in the above paragraphs, and description thereof is not repeated herein. It should be noted that each step of FIG. 9 and FIG. 10 may be implemented as a plurality of program codes or circuits, which is not limited by the disclosure. In addition, the method of FIG. 9 and FIG. 10 may be used in combination with the abovementioned exemplary embodiments or be solely used, which is not limited by the disclosure.

In view of the foregoing, in the exemplary embodiments of the disclosure, the selection of command queues and the merging, arrangement, and distribution of command information may be managed by using a double-layer configuration of command queues (the first layer is a plurality of first command queues, and the second layer is a plurality of second command queues) together with the weight information of the first command queue, and the characteristics of the second command information itself. In this way, the design of the flash translation layer may be effectively simplified, and the overall performance of the memory storage device may be improved.

Finally, it is worth noting that the foregoing embodiments are merely described to illustrate the technical means of the disclosure and should not be construed as limitations of the disclosure. Even though the foregoing embodiments are referenced to provide detailed description of the disclosure, people having ordinary skill in the art should understand that various modifications and variations can be made to the technical means in the disclosed embodiments, or equivalent replacements may be made for part or all of the technical features; nevertheless, it is intended that the modifications, variations, and replacements shall not make the nature of the technical means to depart from the scope of the technical means of the embodiments of the disclosure.

What is claimed is:

1. A command information distribution method for a rewritable non-volatile memory module, the command information distribution method comprising:
arranging a plurality of first command queues used to cache in parallel command information from a flash translation layer;
arranging a plurality of second command queues used to cache in parallel command information to be transmitted to the rewritable non-volatile memory module;
extracting first command information from a first target queue among the plurality of first command queues according to weight information corresponding to the plurality of first command queues;
performing information format processing on the first command information to generate second command information; and
distributing the second command information to a second target queue among the plurality of second command queues to wait for execution by the rewritable non-volatile memory module.

2. The command information distribution method according to claim 1, further comprising:
setting a weight value corresponding to each of the plurality of first command queues according to the number of command information cached in each of the plurality of first command queues.

3. The command information distribution method according to claim 1, wherein the step of extracting the first command information from the first target queue among the plurality of first command queues according to the weight information corresponding to each of the plurality of first command queues comprises:
in a queue selection operation, comparing weight values corresponding to each of the plurality of first command queues; and
selecting one of the plurality of first command queues as the first target queue according to a comparison result.

4. The command information distribution method according to claim 3, further comprising:
in response to a first candidate queue among the plurality of first command queues being selected as the first target queue for multiple consecutive times, updating a count value corresponding to the first candidate queue; and
in response to the count value satisfying a predetermined condition, marking the first candidate queue so that the first candidate queue is excluded in the next queue selection operation.

5. The command information distribution method according to claim 4, further comprising:
in response to the first candidate queue not being selected as the first target queue for consecutive times, resetting the count value corresponding to the first candidate queue.

6. The command information distribution method according to claim 1, further comprising:
performing command merging on the first target queue;
in the command merging, selecting first target command information in the first target queue and traversing remaining command information in the first target queue based on the first target command information;
in response to the first target command information and at least one second target command information in the first target queue satisfying a first condition, merging the first target command information and the at least one second target command information;
in response to the first target command information and at least one third target command information in the first target queue satisfying a second condition, adjusting the at least one third target command information to be sequenced after the first target command information; and
ending the command merging after detecting last command information or command information with a barrier flag in the first target queue.

7. The command information distribution method according to claim 6, further comprising:
in response to the first target command information and the at least one second target command information belonging to a same type of commands and the first target command information and the at least one second target command information corresponding to a same memory page or different memory planes, determining that the first target command information and the at least one second target command information satisfy the first condition; and
in response to the first target command information and the at least one third target command information belonging to the same type of commands and the first target command information and the at least one third target command information corresponding to a plurality of consecutive memory pages, determining that the first target command information and the at least one third target command information satisfy the second condition.

8. The command information distribution method according to claim 1, wherein the rewritable non-volatile memory module comprises a plurality of memory chips, and the first target queue and the second target queue correspond to the same memory chip among the plurality of memory chips.

9. A memory storage device, comprising:
a connection interface unit configured to be connected to a host system;
a rewritable non-volatile memory module; and
a memory control circuit unit connected to the connection interface unit and the rewritable non-volatile memory module,
wherein the memory control circuit unit is configured to:
arrange a plurality of first command queues used to cache in parallel command information from a flash translation layer;
arrange a plurality of second command queues used to cache in parallel command information to be transmitted to the rewritable non-volatile memory module;
extract first command information from a first target queue among the plurality of first command queues according to weight information corresponding to the plurality of first command queues;
perform information format processing on the first command information to generate second command information; and
distribute the second command information to a second target queue among the plurality of second command queues to wait for execution by the rewritable non-volatile memory module.

10. The memory storage device according to claim 9, wherein the memory control circuit unit is further configured to:
set a weight value corresponding to each of the plurality of first command queues according to the number of command information cached in the plurality of first command queues.

11. The memory storage device according to claim 9, wherein the operation of extracting the first command information from the first target queue among the plurality of first command queues according to the weight information corresponding to the plurality of first command queues by the memory control circuit unit comprises:
in a queue selection operation, comparing weight values corresponding to the plurality of first command queues; and
selecting one of the plurality of first command queues as the first target queue according to a comparison result.

12. The memory storage device according to claim 11, wherein the memory control circuit unit is further configured to:
in response to a first candidate queue among the plurality of first command queues being selected as the first target queue for multiple consecutive times, update a count value corresponding to the first candidate queue; and
in response to the count value satisfying a predetermined condition, mark the first candidate queue so that the first candidate queue is excluded in the next queue selection operation.

13. The memory storage device according to claim 12, wherein the memory control circuit unit is further configured to:
in response to the first candidate queue not being selected as the first target queue for consecutive times, reset the count value corresponding to the first candidate queue.

14. The memory storage device according to claim 9, wherein the memory control circuit unit is further configured to:
perform command merging on the first target queue;
in the command merging, select first target command information in the first target queue and traverse remaining command information in the first target queue based on the first target command information;
in response to the first target command information and at least one second target command information in the first target queue satisfying a first condition, merge the first target command information and the at least one second target command information;
in response to the first target command information and at least one third target command information in the first target queue satisfying a second condition, adjust the at least one third target command information to be sequenced after the first target command information; and
end the command merging after detecting last command information or command information with a barrier flag in the first target queue.

15. The memory storage device according to claim 14, wherein the memory control circuit unit is further configured to:
in response to the first target command information and the at least one second target command information belonging to a same type of commands and the first target command information and the at least one second target command information corresponding to a same memory page or different memory planes, determine that the first target command information and the at least one second target command information satisfy the first condition; and
in response to the first target command information and the at least one third target command information belonging to the same type of commands and the first target command information and the at least one third target command information corresponding to a plurality of consecutive memory pages, determine that the first target command information and the at least one third target command information satisfy the second condition.

16. The memory storage device according to claim 9, wherein the rewritable non-volatile memory module comprises a plurality of memory chips, and the first target queue and the second target queue correspond to the same memory chip among the plurality of memory chips.
